(19) United States
(12) Patent Application Publication
(10) Pub. No.: US 2026/0078008 A1
(43) Pub. Date: Mar. 19, 2026

(54) PRODUCTION OF SILICON PARTICLES HAVING A REDUCED SURFACE METAL CONTENT

(71) Applicant: Wacker Chemie AG, Munich (DE)

(72) Inventors: Marco GRUBER, Erlangen (DE); Rebecca BERNHARD, Waldkrailburg (DE); Sebastian LIEBISCHER, Muhldorf (DE); Gerlinde WENSAUER, Altotting (DE)

(73) Assignee: Wacker Chemie AG, Munich (DE)

(21) Appl. No.: 19/106,233

(22) PCT Filed: Sep. 22, 2022
(86) PCT No.: PCT/EP2022/076405

§ 371 Date: Feb. 25, 2025

(51) Int. Cl. C01B 33/037

(52) U.S. Cl. CPC C01B 33/037; C01P 2004/61; C01P 2006/12; C01P 2006/80

(57) ABSTRACT

Silicon chunks with reduced surface metal content and methods for producing the same. Where the method for producing the silicon chunks include the steps of (a) comminuting a silicon ingot or block into silicon chunks, (b) contacting the silicon chunks with at least one preliminary etching bath, comprising 6.6% to 12% by weight of hydrofluoric acid and 40% to 65% by weight of nitric acid, and (c) contacting the silicon chunks with at least one main etching bath, comprising 5.3% to 6.5% by weight of hydrofluoric acid and 40% to 65% by weight of nitric acid.

The invention relates to a method for producing silicon chunks with reduced surface metal content, in which a silicon ingot or block is comminuted and the resulting silicon chunks are contacted with a preliminary etching bath and at least one main etching bath.

Polycrystalline silicon (polysilicon) is customarily produced by the Siemens process (process of chemical gas-phase deposition). Polysilicon is the starting material in the production of monocrystalline silicon, which is produced, for example, by means of the Czochralski process. In addition, polysilicon is required for the production of multicrystalline silicon, for example by means of block casting processes. For both processes, the polysilicon obtained in the form of an ingot in accordance with the Siemens process has to be comminuted into chunks.

In semiconductor applications, the reduction of surface contamination is a priority and is crucial in order not to negatively affect the minority charge carrier lifetime (recombination and generation lifetime) and also to avoid micrometal precipitates. For chip applications, for example, the total content of metallic impurities may only be in the pptw range.

The process of comminuting the polysilicon is fundamentally a source of contamination, especially for metals. Comminution usually takes place using roll or jaw crushers. Although the use of particularly abrasion-resistant materials (e.g., tungsten carbide, silicon nitride, silicon carbide and polycrystalline diamonds) can reduce metal contamination, a certain level of abrasion during the comminuting procedure can never be entirely prevented. Therefore, cleaning of the comminuted polysilicon is indispensable, at least for the above-stated further use.

Cleaning mainly takes place using wet-chemical etching processes, wherein the comminuted polysilicon is successively transferred into different acid and/or alkali baths. The aim of the cleaning is to remove the surface impurities, such as metals and dopants, but also greases and oils. In particular, the removal of the element tungsten presents a challenge because, owing to the common usage of WC/Co-based crushing tools, uncleaned material after crushing can have a tungsten content of 400-1000 pptw.

U.S. Pat. No. 6,309,467 B1 discloses silicon chunk with a content of Fe and Cr of less than 6.66*10-11 g/cm². This is obtained by a multistage wet-chemical process wherein the material passes through different corrosive HF/HNO3 and purifying (HF, HCl and H₂O₂) baths. The material is guided through the individual tanks by raising and lowering movements. However, tungsten cannot be removed efficiently from the Si surface.

US 2010/0132746 A1 describes a cleaning apparatus with a multiplicity of etching baths. The HNO₃ content here increases continuously from the first to the last etching bath. The HF content in all the baths is only 0.1%-0.5%. The cleaned material still has a surface metal content of less than 0.01 ng/mL, which is likely due to the low HF content.

US 2021/0114884 A1 discloses an etching process, in particular for the removal of tungsten on the silicon surface. Three etching baths are passed through, the middle bath containing an aqueous alkali solution with H₂O₂ and tetramethylammonium hydroxide (TMAH) and the other two containing an HF/HNO₃ solution. The surface metal content after the treatment is 15 pptw or less, with the tungsten content being 0.9 pptw or less.

In addition to HF/HNO₃-based steps, the cleaning process according to US 2014/0037959 A1 also includes an alkaline etching step. In contrast to US 2021/0114884 A1, this step takes place by way of introduction. Disadvantages of alkaline cleaning steps are the generally slow reaction times, which prevents particularly rapid sequencing of a cleaning system. Furthermore, organic bases such as TMAH can lead to an increase in the carbon content on the surface. In addition, the handling of a further corrosive component gives rise to additional equipment costs.

US 2013/0189176 A1 describes a two-stage cleaning process for polysilicon, which passes through a pickling mixture (HF/HCl/H₂O₂) and then an etching bath (HF/HNO₃). The cleaned material has a surface metal content of between 10 to 100 pptw. The tungsten content is reported as 0.1 to 10 pptw. Here, however, the comminution of the polysilicon does not take place using crushing tools containing tungsten carbide. The described cleaning conditions would not be sufficient for the efficient removal of tungsten impurities resulting from the use of tungsten-containing crushing tools.

Arising from the stated disadvantages, the object of the present invention was to provide an efficient method for removing surface metals wherein as few different chemicals as possible are used. The focus here is on efficient removal of tungsten.

This object is achieved by a method for producing silicon chunks, preferably polysilicon chunks, with reduced surface metal content, comprising the steps of
a) comminuting a silicon ingot or block into silicon chunks,
b) contacting the silicon chunks with at least one preliminary etching bath, containing 6.6% to 12% by weight of hydrofluoric acid (HF) and 40% to 65% by weight of nitric acid (HNO₃),
c) contacting the silicon chunks with at least one main etching bath, containing 5.3% to 6.5% by weight of HF and 40% to 65% by weight of HNO₃.

Regarding the comminution of the silicon and the equipment for carrying out the method, reference may be made to US 2006/008970 A1 and US 2014/0037959 A1.

The contacting of the silicon chunks with the respective etching bath takes place preferably through a combination of lowering and raising movements, with the chunks being in a process pan and the etching solutions being each in a reservoir tank. In other words, therefore, the contacting may comprise a dipping process. The composition of the etching baths can be monitored continuously via titration.

Surprisingly, it has emerged that the treatment of the silicon chunks in at least one upstream etching bath, which has an increased HF concentration compared to the main etching bath, can achieve significantly better tungsten removal. With particular advantage, this improvement is not at the expense of poorer removal of other metals from the total surface metal content (SFM) contemplated. In addition to tungsten, the metals under consideration were as follows: Fe, Cr, Ni, Al, Ca, Ag, Zn, As, Co, Cu, Na, K, Ti, Mg, Mo, Mn, Sn, Ba, Bi, Cd, Li, Pb, Sb, Sr, Ti, U, V, Y, Zr. The total SFM is the sum total of the stated metals in pptw and is referred to hereinafter as SFM. The total SFM could be reduced by the method of the invention in the 99% quantile in total to less than 13 pptw, preferably less than 12 pptw, more preferably less than 11 pptw.

Furthermore, it is advantageous that the cleaning method of the invention could be limited to the handling of only one corrosive solution (HNO₃/HF).

Preferably, the silicon chunks are contacted with only one preliminary etching bath.

Preferably, the preliminary etching bath contains 6.6% to 12%, more preferably 7% to 10%, by weight of HF.

The contact time of the silicon chunks in the preliminary etching bath is preferably 1 to 30 s, more preferably 2 to 25 s, more particularly 4 to 20 s. The etching ablation caused by this is thus typically only about 1 to 3 μm.

The temperature of the preliminary etching bath is preferably 1 to 60° C., more preferably 5 to 50° C., more particularly 8 to 40° C. The temperature in the etching circuit can be detected via a temperature sensor (measuring principle: PT100) in the media circuit and controlled to a setpoint value. Further monitoring can be performed via an additional temperature sensor (measuring principle: PT100) directly in the etching bath.

According to one particularly preferred embodiment, the temperature of the preliminary etching bath is set in dependence on the chunk size class of the silicon chunks to be cleaned. The temperature for a chunk size of 2 (CS2) is preferably 1 to 10° C., for CS3 preferably 8 to 60° C. and for CS4 preferably 1 to 15° C.

Chunk size classes 0 to 4 (CS0 to CS4) are basically defined using the grain size of the chunks, where the grain size is defined as the longest distance between two points on the surface of a silicon chunk. The chunk size classes subsume fractions with grain size ranges as follows.
CS0: 1 to 6 mm
CS1:3 to 15 mm
CS2:4 to 45 mm
CS3:10 to 65 mm
CS4:20 to 150 mm

Chunks of the CS4 generally have the smallest specific surface area and the lowest tungsten contamination from the crushing process. The reason for this is the only one-time contact with the crushing tool (e.g., two-roll crusher). Therefore, the contamination level is fairly low and removal by cleaning at reduced etching temperatures is possible.

Chunks of the CS2 generally have the highest specific surface area and thus an increased tungsten contamination from the crushing process. The large surface area causes high local temperatures to occur on the chunks during the etching process. For reliable reaction control, the etching bath temperatures are therefore usually kept lower.

Chunks of the CS3 generally exhibit the most unfavorable relationship between specific surface area, tungsten contamination and local temperatures at the chunk surface during etching. To obtain more effective removal by cleaning, the etching bath temperature is therefore usually increased.

The silicon chunks can be classified by means of mesh sieves, with the edge length of the square meshes corresponding to the upper limit of a CS. For example, US 2016/0214141 A1 describes a classifying process using vibrating sieves.

Preferably, a CS comprises at least 90% by weight of silicon chunks within the respective size range.

Beds of (silicon) chunks with preferably narrow chunk size distributions are usually measured and analyzed using a particle size instrument. Preferably for CS3 and CS4, the weight is first determined gravimetrically and then the maximum chunk length and width of individual chunks is determined optically by means of image processing. Below the chunk size CS3, the maximum chunk length and width are determined by the principle of light/laser scattering.

From the calculated mean length-to-weight ratio or width-to-length ratio (aspect ratio), conclusions can be drawn about the cubicity or roundness of chunk beds. For CS4, the aspect ratio of weight to maximum length is preferably in a value range between 0.2 and 1.0 mm/g; for CS3, a typical value range is between 1.2 and 5.0 mm/g. For CS2 and smaller than 45 mm, when using light/laser scattering measurement, the ratio of width to length is formed. The aspect ratio here represents the more cubic volume fraction of the bed, which falls below the width-to-length ratio of 0.5. This value is preferably between 0.4 to 0.8.

The morphology of the chunks treated by means of the method of the invention is fundamentally irrelevant for its implementation/effectiveness.

The at least one main etching bath in method step c) preferably has a temperature of 1 to 15° C., more preferably of 2 to 12° C., more particularly of 4 to 10° C. If two or more main etching baths are used, it is preferred that they do not differ in their temperature or do so only insignificantly (fluctuation range±1° C.).

The silicon chunks are particularly preferably contacted with only one main etching bath. Preferably, the main etching bath here contains 53% to 65% by weight of HNO₃.

The residence time (immersion time) of the silicon chunks is preferably 35 to 180 s with only one main etching tank, more preferably 60 to 150 s.

Furthermore, it may be preferred to contact the silicon chunks in step c) with a first and a second main etching bath, in which case the second main etching bath has a higher content of HNO₃. Preferably, the first main etching bath contains 40% to 65% by weight, more preferably 45% to 60% by weight of HNO₃, and the second main etching bath 53% to 65% by weight of HNO₃.

The residence time of the silicon chunks when using two main etching tanks is preferably 35 to 180 s, more preferably 60 to 150 s, in the first and preferably 35 to 180 s, more preferably 60 to 150 s, in the second main etching bath.

If more than two main etching baths are used, the content of HNO₃ preferably increases from the first to the last main etching bath.

The HF content preferably remains constant.

The acid mixture from the main etching bath can be supplied via a cascade through a tank overflow to the preliminary etching bath. Such a cascade is beneficial to the economical utilization of the acid. By means of specific metering, the required concentrations of the respective etching tanks are established and maintained.

The method after step c) preferably comprises a further step d), in which the silicon chunks are contacted with a hydrophilizing bath containing an ozone-water mixture with 5 to 30 ppm, preferably 7 to 15 ppm, of ozone.

Furthermore, it may be preferred that after each of the steps a), b), c) and optionally d), the silicon chunks are contacted with an ultrapure water bath. The contacting with the ultrapure water bath may also take place after only one or two or more of the steps a) to d).

Preferably, so-called entry washing of the silicon chunks takes place in an ultrapure water bath after the comminuting in step a) and before the transfer into the preliminary etching bath.

Furthermore, it is preferred that the silicon chunks after step d) are contacted with an ultrapure water bath, which preferably has a temperature of 50 to 95° C., more preferably of 60 to 90° C.

The preferred residence time of the silicon chunks in the ultrapure water bath (regardless of which method step it follows) is 15 to 180 s, more preferably 30 to 150 s.

Preferably, no ultrapure water bath is arranged between the preliminary etching bath and the at least one main etching bath.

Under certain circumstances, the silicon chunks can additionally be contacted with a pickling bath. This bath preferably contains 10% to 13% by weight of HCl, 4% to 6.5% by weight of HF and 1.4% to 2% by weight of hydrogen peroxide. The pickling bath can be arranged in particular between steps a) and b).

The method may comprise a drying step in which the silicon chunks are dried by convection drying and/or vacuum drying.

The drying step may follow step c), step d) or an ultrapure water bath after one of the stated steps.

Preferably, an ultrapure water bath with a temperature of 80° C. to 95° C. (hot water washing) is arranged before the drying step.

Preferably, the drying step comprises a convection drying at 60 to 100° C., preferably at 70 to 90° C., directly followed by a vacuum drying at 2 to 8 kPa (temperature range 18 to 25° C.), preferably at 3 to 5 kPa. Typical residence times of the silicon chunks in the convection drying are 800 to 3000 s (e.g., 1250 s at 80° C.). In the vacuum drying, the times are typically 50 to 400 s (e.g., 100 s at room temperature and 3.5 kPa).

A further aspect of the invention relates to silicon chunks, more particularly produced according to the method described, which have an SFM in the 99% quantile of less than 20 pptw, preferably less than 15 pptw, more preferably less than 11 pptw, more particularly less than 8 pptw. The following metals are taken into consideration when determining the surface metal content: Fe, Cr, Ni, Al, Ca, Ag, W, Zn, As, Co, Cu, Na, K, Ti, Mg, Mo, Mn, Sn, Ba, Bi, Cd, Li, Pb, Sb, Sr, Tl, U, V, W, Y, Zr.

The content of tungsten in the 99% quantile is preferably ≤1 pptw, more preferably ≤0.6 pptw, more particularly ≤0.3 pptw.

The content of Fe, Cr, Ni and W is preferably ≤5 pptw, more preferably ≤4 pptw, more particularly ≤3 pptw.

The surface metal content can be determined in accordance with SEMI MF1724. A mixture of HF (40% by weight)/HNO₃ (65% by weight) in a ratio of 1/4 v/v (e.g., 250 mL of HF and 750 mL of HNO₃) is used to detach a surface layer of the chunks (overetching), which are then fumed until dry. The residue is redissolved in a beaker with HF (40% by weight)/HNO₃ (65% by weight) in a ratio of 1/1 v/v (e.g., 25 μL of each) and H₂O (e.g., 1450 μL per sample) and then analyzed by inductively coupled plasma mass spectrometry (ICP-MS; Agilent 8900-ICP QQQ). The initial mass of chunks is weighed out depending on the chunk size and is adapted to the specific surface area. It is between 15 to 180 g.

The detection limits (method detection limit; MDL) are computed using the blank scattering. Calculation as follows according to DIN 32486 direct method (blank value method), specified in the guideline on method validation in the BLMP (German Federation/State measuring program; ISSN 0722-186X), is used for this purpose:

$$MDL [ pptw ] = 3 * standard deviation of blanks [ \frac{ng}{mL} ] * \frac{redissolution volume [ mL ] ( e . g . , 3 mL ) * 100 \; 0 [ \frac{pg}{ng} ]}{initial sample mass [ g ]}$$

The detection limits for the various elements on an annual average are 0.06 pptw for W; 1.03 pptw for Fe; 0.27 pptw for Cr; 0.51 pptw for Ni. The detection limits of the other elements from the series Al, Ca, Ag, Zn, As, Co, Cu, Na, K, Ti, Mg, Mo, Mn, Sn, Ba, Bi, Cd, Li, Pb, Sb, Sr, Tl, U, V, W, Y and Zr are between 0.01 pptw and 2.01 pptw on an annual average. The elements Mo, Li, V, Mn, Zr, Pb, Sr, Y, Bi, Cd, Tl and U are situated here at not more than 0.03 pptw. Co, Ba and As are situated at not more than 0.07 pptw and Na, Mg, Al, K, Ti, Cu, Zn, Ag, Sn and Sb at not more than 0.78 pptw. Ca as an environmental element has the highest detection limit of 2.01 pptw. This results in an average detection limit of 0.3 pptw over all 30 elements.

### EXAMPLES

### General Information:

Polycrystalline polysilicon is crushed with a WC/Co-containing crushing tool (WC). Contamination with tungsten poses a challenge. Because of the so-called keep-it-clean handling of the resulting polysilicon chunk between crushing and packaging, cross-contamination by contact with foreign surfaces (e.g. gloves, metallic surfaces, etc.) is prevented (keep-it-clean concept). Cleaning of the chunks in the etching system in specific 5-kg process pans enables direct and contactless packaging of the chunks in a clean room in product bags (no-touch principle). Keep-it-clean thus describes a concept that ensures that the crushed Si pieces come into contact with as few potentially contaminated surfaces as possible up to the packaging step. In this way, the etching ablation can be reduced to a minimum. The Si chunks have a specific surface area of 1200 to 3500 cm²/kg, depending on the chunk size and the morphological properties. Employed as a suitable measurement method is dynamic image analysis, depending on the chunk size, using, e.g., a Camsizer from Retsch or Haver Böcker (Geometric product specifications (GPS)—Dimensional measuring equipment; Height gauges-Design and metrological characteristics (ISO 13225:2012); German version EN ISO 13225:2012).

Morphological properties of the chunks can be detected by means of camera systems and expressed by a morphology index as disclosed in WO 2021/121558 A1.

5 kg of silicon chunks are used in each of the examples. The chunks originate from the same batch from a Siemens process. The chunks are located in process carriers for 5-kg product quantities, preferably made of plastic (e.g., PVDF), and are immersed successively into the various cleaning baths. The etching baths are made of polyvinylidene fluoride. Typical filling quantities of the baths are between 300 and 700 L. The cleaning process proceeds automatically in a cleaning line, with immersion being brought about by lowering and raising movements. The acid composition of the baths is monitored continuously via pH titration.

The analysis of the cleaned product was carried out in each case after the last process step by means of chunk size-dependent sample quantity via ICP-MS (for method description see SEMI MF1724). For CS3, the sample quantity is about 80 g.

### Example 1

5 kg of CS3 silicon chunks pass through the following process steps:
Preliminary etching bath: 45% by weight HNO₃ and 7.0% by weight HF in ultrapure water; bath temp.: 50° C.; residence time: 4 s (in general, the residence time can be realized by either single or multiple immersion).
Main etching bath: 50% by weight HNO₃ and 5.8% by weight HF in ultrapure water; bath temp.: 8° C.; residence time: 130 s
Ultrapure water bath: bath temp.: 18° C.; residence time: 120 s;
Convection drying: temp. 80° C.; residence time: 1250 s
Vacuum drying: pressure: 3.5 kPa; residence time: 100 s

### Example 2

5 kg of CS2 silicon chunks pass through the process steps set out under example 1. In contrast to example 1, the temperature of the preliminary etching bath is 4° C. and the residence time in the main etching tank (temp. 5° C.) is only 100 s.

### Example 3

5 kg of CS4 silicon chunks pass through the process steps set out under example 1. In contrast to example 1, the temperature of the preliminary etching bath is 4° C. and the residence time in the main etching tank (temp. 8° C.) is only 100 s.

### Example 4

5 kg of CS2 silicon chunks with non-compact morphology (chunks have growth structures such as dendrites/coral, cracks and holes) pass through the process steps set out under example 1. In contrast to example 1, the temperature of the preliminary etching bath is 4° C. and the residence time in the main etching tank is only 100 s at a temperature of 5° C.

### Comparative Example 1

5 kg of CS3 silicon chunks pass through process steps as follows:
Main etching bath: 50% by weight HNO₃ and 5.8% by weight HF in ultrapure water; bath temp.: 8° C.; residence time: 130 s
Ultrapure water bath: rinsing tank after the main etching tank, bath temp.: 18° C.; residence time: 120 s
Convection drying: temp.: 80° C.; residence time: 1250 s
Vacuum drying: pressure: 3.5 kPa; residence time: 100 s

### Comparative Example 2

5 kg of CS2 silicon chunks pass through process steps as follows:
Main etching bath: 5.8% by weight HF; 50% by weight HNO₃; bath temp: 5° C.; residence time: 100 s
Ultrapure water bath: bath temp.: 18° C.; residence time: 120 s;
Convection drying: temp. 80° C., dwell time: 1250 s
Vacuum drying: pressure: 3.5 kPa; residence time: 100 s

### Comparative Example 3

5 kg of CS4 silicon chunks pass through the process steps from comparative example 2, with the difference that the temperature of the main etching bath is 8° C.

### Comparative Example 4

5 kg of CS2 silicon chunks with non-compact morphology pass through the process steps described in comparative example 2.

### Comparative Example 5

5 kg of CS3 silicon chunks pass through process steps as follows:
Pickling bath: HCl content: 12% by weight; HF content: 5% by weight, H₂O₂ content: 2% by weight; bath temp.: 18° C.; residence time: 415 s
Ultrapure water bath: bath temp.: 18° C.; residence time: 80 s
Main etching bath: HF content 5.8% by weight; HNO₃ content 50% by weight; bath temp.: 8° C.; residence time: 130 s
Ultrapure water bath: bath temp.: 18° C.; residence time: 150 s
Convection drying: temp.: 80° C.; residence time: 1250 s
Vacuum drying: pressure: 3.5 kPa; residence time: 100 s

Table 1 summarizes the inventive examples 1 to 4.

TABLE 1

| | | | | | | Efficiency | Efficiency |
|---|---|---|---|---|---|---|---|
| | | | SFM | | Fe/Cr/ | W | Fe/W |
| | | No. of | tot.* | W | Ni/W | cleaning | cleaning |
| | Material | samples | [pptw] | [pptw] | [pptw] | [%] | [%] |
| Uncleaned | CS2-4 ASS | N = 150 | 1991 | 266 | 1281 | — | — |
| Inv. Ex. 1 | CS3 ASS | N = 102 | 4.0 | 0.6 | 2.4 | 99.8 | 99.8 |
| Inv. Ex. 2 | CS2 ASS | N = 108 | 5.9 | 0.2 | 1.5 | 99.9 | 99.9 |
| Inv. Ex. 3 | CS4 ASS | N = 120 | 2.8 | 0.3 | 0.9 | 99.9 | 99.9 |
| Inv. Ex. 4 | CS2 ASS | N = 110 | 5.3 | 0.5 | 2.2 | 99.8 | 99.8 |

*Fe, Cr, Ni, Al, Ca, Ag, W, Zn, As, Co, Cu, Na, K, Ti, Mg, Mo, Mn, Sn, Ba, Bi, Cd, Li, Pb, Sb, Sr, Tl, U, V, Y, Zr

Table 2 summarizes the comparative examples 1 to 5.

TABLE 2

| | | | | | | Efficiency | Efficiency |
|---|---|---|---|---|---|---|---|
| | | | SFM | | Fe/Cr/ | W | Fe/W |
| | | No. of | tot.* | W | Ni/W | cleaning | cleaning |
| | Material | samples | [pptw] | [pptw] | [pptw] | [%] | [%] |
| Uncleaned | CS2-4 ASS | N = 150 | 1991 | 266 | 1281 | — | — |
| Comp. Ex. 1 | CS3 ASS | N = 104 | 14.8 | 3.3 | 5.2 | 98.8 | 99.6 |
| Comp. Ex. 2 | CS2 ASS | N = 108 | 19.3 | 1.1 | 6.2 | 99.6 | 99.5 |
| Comp. Ex. 3 | CS4 ASS | N = 120 | 18.7 | 1.2 | 7.5 | 99.5 | 99.5 |
| Comp. Ex. 4 | CS2 ASS | N = 102 | 14.2 | 2.3 | 6.7 | 99.1 | 99.5 |
| Comp. Ex. 5 | CS3 ASS | N = 105 | 29.1 | 1.1 | 10.4 | 99.6 | 99.4 |

*Fe, Cr, Ni, Al, Ca, Ag, W, Zn, As, Co, Cu, Na, K, Ti, Mg, Mo, Mn, Sn, Ba, Bi, Cd, Li, Pb, Sb, Sr, Tl, U, V, Y, Zr

1-17. (canceled)

18. A method for producing silicon chunks with reduced surface metal content, comprising the steps of:
a) comminuting a silicon ingot or block into silicon chunks;
b) contacting the silicon chunks with at least one preliminary etching bath, comprising 6.6% to 12% by weight of hydrofluoric acid and 40% to 65% by weight of nitric acid;
c) contacting the silicon chunks with at least one main etching bath, comprising 5.3% to 6.5% by weight of hydrofluoric acid and 40% to 65% by weight of nitric acid.

19. The method of claim 18, wherein the preliminary etching bath comprises 6.6% to 12%, preferably 7% to 10%, by weight of hydrofluoric acid.

20. The method of claim 18, wherein the contact time in the preliminary etching bath is 1 to 30 s, preferably 2 to 25 s, more preferably 4 to 20 s.

21. The method of claim 18, wherein the preliminary etching bath has a temperature of 1 to 60° C., preferably 5 to 50° C., more preferably 8 to 40° C.

22. The method of claim 18, wherein the temperature of the preliminary etching bath is set in dependence on the chunk size of the silicon chunks, with the temperature being
from 1 to 10° C. for chunk size 2,
from 8 to 60° C. for chunk size 3, and
from 5 to 15° C. for chunk size 4.

23. The method of claim 18, wherein the at least one main etching bath has a temperature of 1 to 15° C., preferably of 2 to 12° C., more preferably of 4 to 10° C.

24. The method of claim 18, wherein the silicon chunks are contacted in step c) with a main etching bath, this bath comprising preferably 53% to 65% by weight of nitric acid.

25. The method of claim 18, wherein the silicon chunks are contacted in step c) with a first and a second main etching bath, the second main etching bath having a higher content of nitric acid.

26. The method of claim 25, wherein the first main etching bath comprises 40% to 65% by weight of nitric acid and the second main etching bath comprising 53% to 65% by weight of nitric acid.

27. The method of claim 18, wherein after step c) a further step d) of contacting the silicon chunks with a hydrophilizing bath comprising an ozone-water mixture with 5 to 30 ppm, preferably 7 to 15 ppm, of ozone.

28. The method of claim 18, wherein after each step or after each of the individual steps a) to c) and/or after step d), the silicon chunks are contacted with an ultrapure water bath.

29. The method of claim 27, wherein the silicon chunks after step d) are contacted with an ultrapure water bath which has a temperature of 50 to 95° C., preferably of 60 to 90° C.

30. The method of claim 18, wherein a drying step in which the silicon chunks are dried by convection drying and/or vacuum drying.

31. The method of claim 30, wherein the drying step comprises a convection drying at 60 to 100° C., preferably at 70 to 90° C., followed by a vacuum drying at 2 to 8 kPa, preferably at 3 to 5 kPa.

32. A silicon chunk, comprising:
wherein the silicon chunk has a specific surface area of 1200 to 3500 cm²/kg and a grain size in a range from 4 to 150 mm, which has a surface metal content of <11 pptw, the metals under consideration being as follows: Fe, Cr, Ni, Al, Ca, Ag, Zn, As, Co, Cu, Na, K, Ti, Mg, Mo, Mn, Sn, Ba, Bi, Cd, Li, Pb, Sb, Sr, Tl, U, V, W, Y, Zr and the tungsten content being ≤0.3 pptw.

33. The silicon chunk of claim 32, wherein the content of Fe, Cr, Ni and W is ≤3 pptw.
